(19) United States
(12) Patent Application Publication
(10) Pub. No.: US 2026/0057390 A1
(43) Pub. Date: Feb. 26, 2026

(54) SYSTEM AND METHOD FOR AUTOMATED MATCHING OF WIRE TRANSFERS WITH RECEIVABLES

(71) Applicant: JPMorgan Chase Bank, N.A., New York, NY (US)

(72) Inventors: Min DAI, Allendale, NJ (US); Sharath SHETTY, Naperville, IL (US); Puja MITTAL, Princeton Junction, NJ (US)

(73) Assignee: JPMorgan Chase Bank, N.A., New York, NY (US)

(21) Appl. No.: 18/812,750

(22) Filed: Aug. 22, 2024

(51) Int. Cl. G06Q 20/42; G06Q 20/10

(52) U.S. Cl. CPC G06Q 20/42; G06Q 20/10

(57) ABSTRACT

Various methods and processes, apparatuses or systems, and media for using an AI/ML model to perform automated matching of incoming wire transfers with receivables in an accurate and efficient manner are disclosed. The method includes: obtaining first information that is associated with a set of wire transfers; obtaining second information that is associated with a set of receivables; using the AI/ML model to compare the first information with the second information; determining, based on a result of the comparison, a respective probability that each of the wire transfers matches with each of the receivables; and using a result thereof to generate an assessment of respective matched pairings of wire transfers and receivables.

### TECHNICAL FIELD

This disclosure relates to methods and apparatuses for using an artificial intelligence/machine learning (AI/ML) model to perform automated matching of incoming wire transfers with receivables in an accurate and efficient manner.

### BACKGROUND

The developments described in this section are known to the inventors. However, unless otherwise indicated, it should not be assumed that any of the developments described in this section qualify as prior art merely by virtue of their inclusion in this section, or that these developments are known to a person of ordinary skill in the art.

Financial institutions, such as banks, typically execute large numbers of transactions on a daily basis. In many instances, the execution of a particular transaction may entail receiving an incoming wire transfer that is applicable to an account receivable. In some instances, more than one incoming wire transfer may be applicable to a single account receivable; or a single incoming wire transfer may be applicable to more than one account receivable; or more than one incoming wire transfer may be applicable to more than one account receivable. In this aspect, it is important to reconcile the incoming wire transfers with the receivables.

Conventionally, the task of reconciling incoming wire transfers with receivables has required communications with multiple heterogeneous systems and human interventions. The conventional system is prone to system errors and causes a delay and/or a system latency due to inconsistent information in the heterogeneous systems, complexity of the system to communicate with other systems, and/or human errors.

Accordingly, there is a need for a system and/or mechanism to address the problems described herein and other problems in the existing technologies.

### SUMMARY

The present disclosure, through one or more of its various aspects, embodiments, and/or specific features or sub-components, provides, among other features, various systems, servers, devices, methods, media, programs, and platforms for using an AI/ML model to perform automated matching of incoming wire transfers with receivables in an accurate and efficient manner.

According to an aspect of the present disclosure, a method for performing automated matching of incoming wire transfers with receivables is provided. The method may be implemented by at least one processor. The method includes: receiving a first plurality of textual messages that are associated with a corresponding plurality of wire transfers; analyzing each message included in the first plurality of textual messages to determine, for each message, respective first information that includes an amount of a corresponding wire transfer, a date, a name of a payor, and a name of an intended recipient; retrieving, from a memory, a second plurality of textual messages that are associated with a corresponding plurality of receivables; analyzing each message included in the second plurality of textual messages to determine, for each message, respective second information that includes an amount of a corresponding receivable, an expected payment date, a name of an intended payor, and a name of a payee; comparing the first information with the second information; determining, based on a result of the comparing, a respective probability that each particular one of the plurality of wire transfers matches with each particular one of the plurality of receivables; and generating, based on a result of the determining, an assessment of respective matched pairings of wire transfers included in the plurality of wire transfers with receivables included in the plurality of receivables. The comparing may include using a first artificial intelligence/machine learning (AI/ML) model that is trained to employ a natural language processing (NLP) technique to automatically determine a respective term frequency/inverse document frequency (TF/IDF) similarity score for each message included in the first plurality of textual messages with respect to each message included in the second plurality of textual messages.

The method may further include inputting a result of the generating of the assessment of the respective matched pairings to a post consistency filtering process by which information that relates to the respective matched pairings is continually fed back to the first AI/ML model for updating and tuning a training of the first AI/ML model for subsequent operations.

The comparing may further include using the first AI/ML model to determine, for each message included in the first plurality of textual messages with respect to each message included in the second plurality of textual messages, a respective difference between the amount of the corresponding wire transfer and the amount of the corresponding receivable.

The comparing may further include using the first AI/ML model to determine, for each message included in the first plurality of textual messages with respect to each message included in the second plurality of textual messages, a respective difference between the date of the corresponding wire transfer and the expected payment date of the corresponding receivable.

The generating of the assessment may include determining that there is a match between a first one of the plurality of wire transfers and a first one of the plurality of receivables when a corresponding probability that the first one of the plurality of wire transfers matches with the first one of the plurality of receivables exceeds a first predetermined threshold value.

The assessment may include at least one matched pairing of a single wire transfer from among the plurality of wire transfers with a single receivable from among the plurality of receivables, such that the single wire transfer does not match with any other receivable from among the plurality of receivables, and the single receivable does not match with any other wire transfer from among the plurality of wire transfers.

Alternatively and/or additionally, the assessment may include a first matched pairing of a first wire transfer from among the plurality of wire transfers with a first receivable from among the plurality of receivables and at least a second matched pairing of a second wire transfer from among the plurality of wire transfers with the first receivable.

Alternatively and/or additionally, the assessment may include a first matched pairing of a first wire transfer from among the plurality of wire transfers with a first receivable from among the plurality of receivables and at least a second matched pairing of the first wire transfer with a second receivable from among the plurality of receivables.

Alternatively and/or additionally, the assessment may include a first matched pairing of a first wire transfer from among the plurality of wire transfers with a first receivable from among the plurality of receivables, at least a second matched pairing of a second wire transfer from among the plurality of wire transfers with the first receivable, and at least a third matched pairing of the first wire transfer with a second receivable from among the plurality of receivables.

According to another embodiment, a computing apparatus for performing automated matching of incoming wire transfers with receivables is provided. The computing apparatus includes a processor; a memory; and a communication interface coupled to each of the processor and the memory. The processor is configured to: receive, via the communication interface, a first plurality of textual messages that are associated with a corresponding plurality of wire transfers; analyze each message included in the first plurality of textual messages to determine, for each message, respective first information that includes an amount of a corresponding wire transfer, a date, a name of a payor, and a name of an intended recipient; retrieve, from the memory, a second plurality of textual messages that are associated with a corresponding plurality of receivables; analyze each message included in the second plurality of textual messages to determine, for each message, respective second information that includes an amount of a corresponding receivable, an expected payment date, a name of an intended payor, and a name of a payee; compare the first information with the second information; determine, based on a result of the comparison, a respective probability that each particular one of the plurality of wire transfers matches with each particular one of the plurality of receivables; and generate, based on a result of the determination, an assessment of respective matched pairings of wire transfers included in the plurality of wire transfers with receivables included in the plurality of receivables. The processor may be further configured to compare the first information with the second information by using a first AI/ML model that is trained to employ an NLP technique to automatically determine a respective TF/IDF similarity score for each message included in the first plurality of textual messages with respect to each message included in the second plurality of textual messages.

The processor may be further configured to input a result of the generation of the assessment of the respective matched pairings to a post consistency filtering process by which information that relates to the respective matched pairings is continually fed back to the first AI/ML model for updating and tuning a training of the first AI/ML model for subsequent operations.

The processor may be further configured to use the first AI/ML model to determine, for each message included in the first plurality of textual messages with respect to each message included in the second plurality of textual messages, a respective difference between the amount of the corresponding wire transfer and the amount of the corresponding receivable.

The processor may be further configured to use the first AI/ML model to determine, for each message included in the first plurality of textual messages with respect to each message included in the second plurality of textual messages, a respective difference between the date of the corresponding wire transfer and the expected payment date of the corresponding receivable.

The processor may be further configured to determine that there is a match between a first one of the plurality of wire transfers and a first one of the plurality of receivables when a corresponding probability that the first one of the plurality of wire transfers matches with the first one of the plurality of receivables exceeds a first predetermined threshold value.

The assessment may include at least one matched pairing of a single wire transfer from among the plurality of wire transfers with a single receivable from among the plurality of receivables, such that the single wire transfer does not match with any other receivable from among the plurality of receivables, and the single receivable does not match with any other wire transfer from among the plurality of wire transfers.

Alternatively and/or additionally, the assessment may include a first matched pairing of a first wire transfer from among the plurality of wire transfers with a first receivable from among the plurality of receivables and at least a second matched pairing of a second wire transfer from among the plurality of wire transfers with the first receivable.

Alternatively and/or additionally, the assessment may include a first matched pairing of a first wire transfer from among the plurality of wire transfers with a first receivable from among the plurality of receivables and at least a second matched pairing of the first wire transfer with a second receivable from among the plurality of receivables.

Alternatively and/or additionally, the assessment may include a first matched pairing of a first wire transfer from among the plurality of wire transfers with a first receivable from among the plurality of receivables, at least a second matched pairing of a second wire transfer from among the plurality of wire transfers with the first receivable, and at least a third matched pairing of the first wire transfer with a second receivable from among the plurality of receivables.

According to yet another embodiment, a non-transitory computer readable storage medium storing instructions for performing automated matching of incoming wire transfers with receivables is provided. The storage medium includes a set of executable code which, when executed by a processor, causes the processor to: receive a first plurality of textual messages that are associated with a corresponding plurality of wire transfers; analyze each message included in the first plurality of textual messages to determine, for each message, respective first information that includes an amount of a corresponding wire transfer, a date, a name of a payor, and a name of an intended recipient; retrieve, from a memory, a second plurality of textual messages that are associated with a corresponding plurality of receivables; analyze each message included in the second plurality of textual messages to determine, for each message, respective second information that includes an amount of a corresponding receivable, an expected payment date, a name of an intended payor, and a name of a payee; compare the first information with the second information; determine, based on a result of the comparison, a respective probability that each particular one of the plurality of wire transfers matches with each particular one of the plurality of receivables; and generate, based on a result of the determination, an assessment of respective matched pairings of wire transfers included in the plurality of wire transfers with receivables included in the plurality of receivables. When executed by the processor, the executable code may further cause the processor to compare the first information with the second information by using a first AI/ML model that is trained to employ an NLP technique to automatically determine a respective TF/IDF similarity score for each message included in the first plurality of textual messages with respect to each message included in the second plurality of textual messages.

When executed by the processor, the executable code may further cause the processor to input a result of the generation of the assessment of the respective matched pairings to a post consistency filtering process by which information that relates to the respective matched pairings is continually fed back to the first AI/ML model for updating and tuning a training of the first AI/ML model for subsequent operations.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates a computer system for implementing a method for using an AI/ML model to perform automated matching of incoming wire transfers with receivables in an accurate and efficient manner, in accordance with an embodiment.

FIG. 2 illustrates an exemplary diagram of a network environment with a device for using an AI/ML model to perform automated matching of incoming wire transfers with receivables in an accurate and efficient manner, in accordance with an embodiment.

FIG. 3 illustrates a system diagram for implementing a method for using an AI/ML model to perform automated matching of incoming wire transfers with receivables in an accurate and efficient manner, in accordance with an embodiment.

FIG. 4 illustrates an exemplary flow chart of a process for using an AI/ML model to perform automated matching of incoming wire transfers with receivables in an accurate and efficient manner, in accordance with an embodiment.

FIG. 5 illustrates a model design that corresponds to a process for using an AI/ML model to perform automated matching of incoming wire transfers with receivables in an accurate and efficient manner, in accordance with an embodiment.

FIG. 6 illustrates a data flow that corresponds to a process for using an AI/ML model to perform automated matching of incoming wire transfers with receivables in an accurate and efficient manner, in accordance with an embodiment.

FIG. 7 illustrates a logic consistency check that corresponds to a process for using an AI/ML model to perform automated one-to-many matching of incoming wire transfers with receivables in an accurate and efficient manner, in accordance with an embodiment.

FIG. 8 illustrates a logic consistency check that corresponds to a process for using an AI/ML model to perform automated many-to-many matching of incoming wire transfers with receivables in an accurate and efficient manner, in accordance with an embodiment.

### DETAILED DESCRIPTION

In an embodiment, the system in the disclosure may reduce system errors, simplify human interactions with other heterogeneous systems, and/or reduce a delay and/or a system latency in matching wire transfers with receivables. For example, the disclosed systems and methods using a trained artificial intelligence/machine learning (AI/ML) model may also provide technical improvements with respect to system and/or human errors that may be made in matching wire transfers with receivables, such as, for example, errors arising from inconsistent information provided by heterogeneous systems, typographical errors, misspellings, or arithmetic errors, by virtue of the ability to continually upgrade the performance of the AI/ML model via ongoing training thereof.

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

As is traditional in the field of the present disclosure, example embodiments are described, and illustrated in the drawings, in terms of functional blocks, units and/or modules. Those skilled in the art will appreciate that these blocks, units and/or modules are physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies. In the case of the blocks, units and/or modules being implemented by microprocessors or similar, they may be programmed using software (e.g., microcode) to perform various functions discussed herein and may optionally be driven by firmware and/or software. Alternatively, each block, unit and/or module may be implemented by dedicated hardware, or as a combination of dedicated hardware to perform some functions and a processor (e.g., one or more programmed microprocessors and associated circuitry) to perform other functions. Also, each block, unit and/or module of the example embodiments may be physically separated into two or more interacting and discrete blocks, units and/or modules without departing from the scope of the inventive concepts. Further, the blocks, units and/or modules of the example embodiments may be physically combined into more complex blocks, units and/or modules without departing from the scope of the present disclosure.

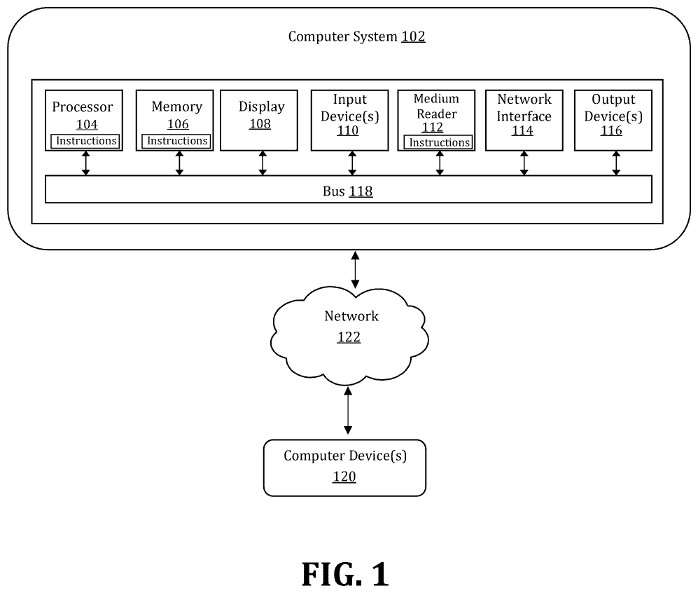

FIG. 1 is an exemplary system 100 for use in implementing a method for using an AI/ML model to perform automated matching of incoming wire transfers with receivables in an accurate and efficient manner, in accordance with an embodiment. The system 100 is generally shown and may include a computer system 102, which is generally indicated.

The computer system 102 may include a set of instructions that may be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term system shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data and executable instructions, and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions may be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid-state display, a cathode ray tube (CRT), a plasma display, or any other known display.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a GPS device, a visual positioning system (VPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g., software, from any of the memories described herein. The instructions, when executed by a processor, may be used to perform one or more of the methods and processes as described herein. In a particular embodiment, the instructions may reside completely, or at least partially, within the memory 106, the medium reader 112, and/or the processor 104 during execution by the computer system 102.

Furthermore, the computer system 102 may include any additional devices, components, parts, peripherals, hardware, software, or any combination thereof which are commonly known and understood as being included with or within a computer system, such as, but not limited to, a network interface 114 and an output device 116. The output device 116 may be, but is not limited to, a speaker, an audio out, a video out, a remote control output, a printer, or any combination thereof.

Each of the components of the computer system 102 may be interconnected and communicate via a bus 118 or other communication link. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is shown in FIG. 1 as a wireless network, those skilled in the art appreciate that the network 122 may also be a wired network.

The additional computer device 120 is shown in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In some embodiments, the modules implemented by the system 100 may be platform, language, database, and cloud agnostic that may allow for consistent easy orchestration and passing of data through various components to output a desired result regardless of platform, browser, language, database, and cloud environment by writing programs accordingly. The configuration or data files, in some embodiments, may be written using JavaScript Object Notation (JSON), but the disclosure is not limited thereto. For example, the configuration or data files may easily be extended to other readable file formats such as Extensible Markup Language (XML), YAML Ain't Markup Language (YAML), etc., or any other configuration-based languages.

In accordance with various embodiments of the present disclosure, the methods described herein may be implemented using a hardware computer system that executes software programs. Further, in a non-limited embodiment, implementations can include distributed processing, component/object distributed processing, and an operation mode having parallel processing capabilities. Virtual computer system processing may be constructed to implement one or more of the methods or functionality as described herein, and a processor described herein may be used to support a virtual processing environment.

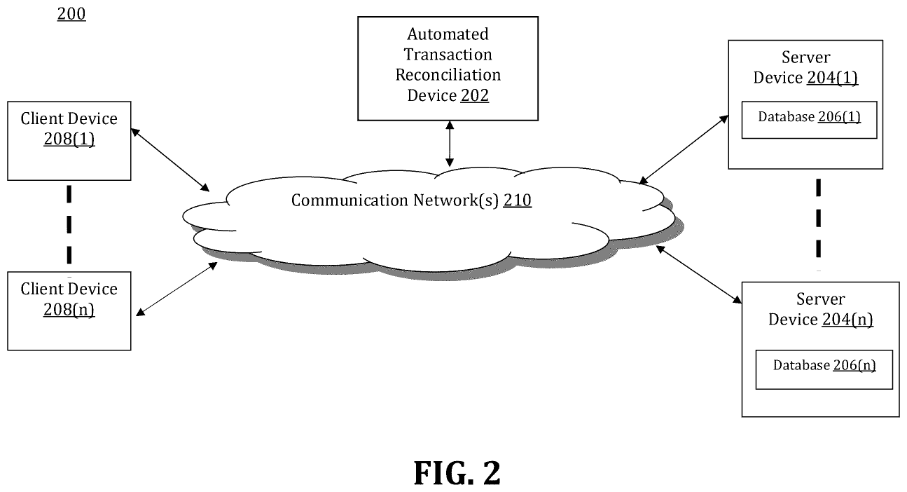

Referring to FIG. 2, a schematic of an exemplary network environment 200 for implementing an automated transaction reconciliation device (ATRD) of the instant disclosure is illustrated.

In some embodiments, the above-described problems associated with conventional tools may be overcome by implementing an ATRD 202 as illustrated in FIG. 2 that may be configured for implementing a method for using an AI/ML model to perform automated matching of incoming wire transfers with receivables in an accurate and efficient manner that is continually improvable by providing ongoing training to the AI/ML model, but the disclosure is not limited thereto.

The ATRD 202 may have one or more computer system 102s, as described with respect to FIG. 1, which in aggregate provide the necessary functions.

The ATRD 202 may store one or more applications that can include executable instructions that, when executed by the ATRD 202, cause the ATRD 202 to perform actions, such as to transmit, receive, or otherwise process network messages, for example, and to perform other actions described and illustrated below with reference to the figures. The application(s) may be implemented as modules or components of other applications. Further, the application(s) may be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the ATRD 202 itself, may be located in virtual server(s) running in a cloud-based computing environment rather than being tied to one or more specific physical network computing devices. Also, the application(s) may be running in one or more virtual machines (VMs) executing on the ATRD 202. Additionally, in one or more embodiments of this technology, virtual machine(s) running on the ATRD 202 may be managed or supervised by a hypervisor.

In the network environment 200 of FIG. 2, the ATRD 202 is coupled to a plurality of server devices 204(1)-204(n) that hosts a plurality of databases 206(1)-206(n), and also to a plurality of client devices 208(1)-208(n) via communication network(s) 210. A communication interface of the ATRD 202, such as the network interface 114 of the computer system 102 of FIG. 1, operatively couples and communicates between the ATRD 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the ATRD 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The ATRD 202 may be a standalone device or integrated with one or more other devices or apparatuses, such as one or more of the server devices 204(1)-204(n), for example. In one particular example, the ATRD 202 may be hosted by one of the server devices 204(1)-204(n), and other arrangements are also possible. Moreover, one or more of the devices of the ATRD 202 may be in the same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the ATRD 202 via the communication network(s) 210 according to the HyperText Transfer Protocol (HTTP)-based and/or JSON protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store various types of data.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. Client device in this context refers to any computing device that interfaces to communications network(s) 210 to obtain resources from one or more server devices 204(1)-204(n) or other client devices 208(1)-208(n).

In some embodiments, the client devices 208(1)-208(n) in this example may include any type of computing device that can facilitate the implementation of the ATRD 202 that may efficiently provide a platform for implementing a method for using an AI/ML model to perform automated matching of incoming wire transfers with receivables in an accurate and efficient manner, but the disclosure is not limited thereto.

The client devices 208(1)-208(n) may run interface applications, such as standard web browsers or standalone client applications, which may provide an interface to communicate with the ATRD 202 via the communication network(s) 210 in order to communicate user requests. The client devices 208(1)-208(n) may further include, among other features, a display device, such as a display screen or touchscreen, and/or an input device, such as a keyboard, for example.

Although the exemplary network environment 200 with the ATRD 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as may be appreciated by those skilled in the relevant art(s).

One or more of the devices depicted in the network environment 200, such as the ATRD 202, the server devices 204(1)-204(n), or the client devices 208(1)-208(n), for example, may be configured to operate as virtual instances on the same physical machine. For example, one or more of the ATRD 202, the server devices 204(1)-204(n), or the client devices 208(1)-208(n) may operate on the same physical device rather than as separate devices communicating through communication network(s) 210. Additionally, there may be more or fewer ATRDs 202, server devices 204(1)-204(n), or client devices 208(1)-208(n) than illustrated in FIG. 2. In some embodiments, the ATRD 202 may be configured to send code at run-time to remote server devices 204(1)-204(n), but the disclosure is not limited thereto.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

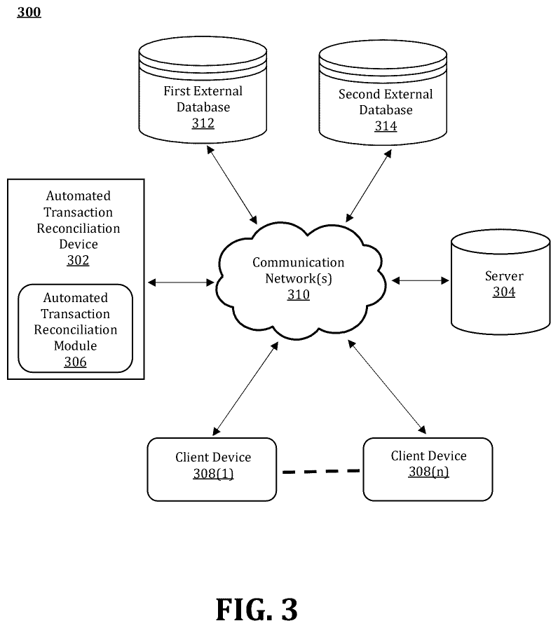

FIG. 3 illustrates a system diagram for implementing an ATRD 302 having an automated transaction reconciliation module (ATRM), in accordance with an embodiment.

As illustrated in FIG. 3, the system 300 may include an ATRD 302 within which an ATRM 306 is embedded, a server 304, a first external database 312, a second external database 314, a plurality of client devices 308(1) . . . 308(n), and a communication network 310.

In some embodiments, the ATRD 302 including the ATRM 306 may be connected to the server 304, and the database(s) 312 via the communication network 310. The ATRD 302 may also be connected to the plurality of client devices 308(1) . . . 308(n) via the communication network 310, but the disclosure is not limited thereto.

In an embodiment, the ATRD 302 is described and shown in FIG. 3 as including the ATRM 306, although it may include other rules, policies, modules, databases, or applications, for example. In some embodiments, the first external database 312 and/or the second external database 314 may be configured to store ready to use modules written for each application programming interface (API) for all environments. Although only one database is illustrated in FIG. 3, the disclosure is not limited thereto. Any number of desired databases may be utilized for use in the disclosed invention herein. The databases 312, 314 may be a mainframe database, a log database that may produce programming for searching, monitoring, and analyzing machine-generated data via a web interface, etc., but the disclosure is not limited thereto.

In some embodiments, the ATRM 306 may be configured to receive real-time feed of data from the plurality of client devices 308(1) . . . 308(n) and secondary sources via the communication network 310.

The plurality of client devices 308(1) . . . 308(n) are illustrated as being in communication with the ATRD 302. In this regard, the plurality of client devices 308(1) . . . 308(n) may be “clients” (e.g., customers) of the ATRD 302 and are described herein as such. Nevertheless, it is to be known and understood that the plurality of client devices 308(1) . . . 308(n) need not necessarily be “clients” of the ATRD 302, or any entity described in association therewith herein. Any additional or alternative relationship may exist between either or both of the plurality of client devices 308(1) . . . 308(n) and the ATRD 302, or no relationship may exist.

The first client device 308(1) may be, for example, a smart phone. Of course, the first client device 308(1) may be any additional device described herein. The second client device 308(n) may be, for example, a personal computer (PC). Of course, the second client device 308(n) may also be any additional device described herein. In some embodiments, the server 304 may be the same or equivalent to the server device 204 as illustrated in FIG. 2.

The process may be executed via the communication network 310, which may comprise plural networks as described above. For example, in an embodiment, one or more of the plurality of client devices 308(1) . . . 308(n) may communicate with the ATRD 302 via broadband or cellular communication. Of course, these embodiments are merely exemplary and are not limiting or exhaustive.

The computing device 301 may be the same or similar to any one of the client devices 208(1)-208(n) as described with respect to FIG. 2, including any features or combination of features described with respect thereto. The ATRD 302 may be the same or similar to the ATRD 202 as described with respect to FIG. 2, including any features or combination of features described with respect thereto.

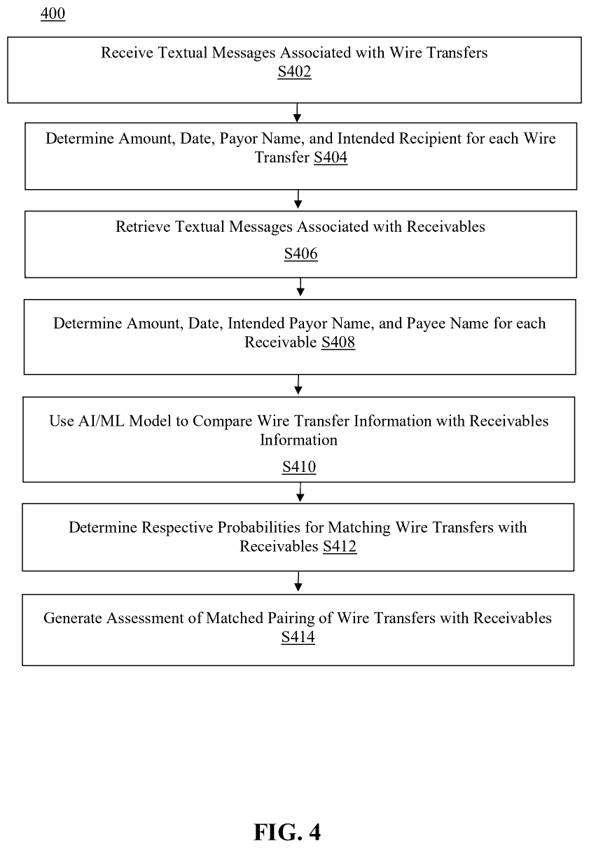

FIG. 4 illustrates an exemplary flow chart of a process 400 implemented by the ATRM 306 of FIG. 3 for enablement of a system and a method for using an AI/ML model to perform automated matching of incoming wire transfers with receivables in an accurate and efficient manner, in accordance with an embodiment. It may be appreciated that the illustrated process 400 and associated steps may be performed in a different order, with illustrated steps omitted, with additional steps added, or with a combination of reordered, combined, omitted, or additional steps.

As illustrated in FIG. 4, at step S402, the process 400 may include receiving a first set of textual messages that are associated with a corresponding set of incoming wire transfers. In this aspect, each textual message includes text that describes a particular incoming wire transfer, whereas the wire transfer refers to the actual execution of the transaction. In an embodiment, an incoming wire transfer may be associated with a textual message that includes any one or more of a name of a payor, a name and/or an address of a financial institution associated with the payor, a name of a payee, a name and/or an address of a financial institution associated with the payee, an amount of currency, an execution time, and a tracking number, but the disclosure is not limited thereto. In an embodiment, a particular textual message may be received as a result of a human inputting the textual message into a client device, such as, for example, a personal computer (PC) or a smartphone, and using the client device to transmit the textual message to the ATRD 302. However, the disclosure is not limited thereto, and other mechanisms for receiving textual messages may be employed, such as, for example, via a voice message that is transmitted via telephone.

At step S404, the process 400 may include analyzing each message included in the first set of textual messages to determine, for each message, respective first information that relates to the corresponding wire transfer. In an embodiment, the analysis of a particular message may include parsing the particular message to extract the first information, based on any one or more of format, spacing, symbols including separation such as periods, commas, slashes, or other grammatical symbols, and textual content. In an embodiment, the first information includes at least one of: an amount of currency of the corresponding wire transfer, a date on which the corresponding wire transfer was made, a name of a payor, or a name of an intended recipient. In an embodiment, the first information may be directly included in the body of a particular textual message. Alternatively, at least a portion of the first information may not be directly included in a particular textual message. For example, if the particular textual message includes a name of a financial institution and an identification number that is associated with the financial institution, the first information may also include an address of the financial institution that is retrievable from another source based on the name and identification number.

At step S406, the process 400 may include retrieving, from a memory, a second set of textual messages that are associated with a corresponding set of receivables. Alternatively, at least a subset of the second set of textual messages may be received from an external source. In this aspect, each of the second set of textual messages includes text that describes a particular receivable, whereas the receivable refers to the potential transaction. In an embodiment, a particular receivable may be associated with a textual message that includes any one or more of a name of a debtor/potential payor, a name and/or an address of a financial institution associated with the potential payor, a name of a creditor/potential payee, a name and/or an address of a financial institution associated with the potential payee, an amount of currency, an execution time, and a tracking number, but the disclosure is not limited thereto. In an embodiment, a particular textual message may be retrieved from a data repository that tracks receivables. However, the disclosure is not limited thereto, and other mechanisms for obtaining textual messages may be employed, such as, for example, receiving a textual message that is generated as a result of a human inputting the textual message into a client device, such as, for example, a personal computer (PC) or a smartphone, and using the client device to transmit the textual message to the ATRD 302; or via a voice message that is transmitted via telephone.

At step S408, the process 400 may include analyzing each message included in the second set of textual messages to determine, for each message, respective second information that relates to the corresponding receivable. In an embodiment, the analysis of a particular one of the second set of textual messages may include parsing the particular message to extract the second information, based on any one or more of format, spacing, symbols including separation such as periods, commas, slashes, or other grammatical symbols, and textual content. In an embodiment, the second information includes at least one of: an amount of currency of the corresponding receivable, an expected payment date for the corresponding receivable, a name of an intended payor, and a name of a payee. In an embodiment, the second information may be directly included in the body of a particular textual message. Alternatively, at least a portion of the second information may not be directly included in a particular textual message. For example, if the particular textual message includes a name of a financial institution and an identification number that is associated with the financial institution, the second information may also include an address of the financial institution that is retrievable from another source based on the name and identification number.

At step S410, the process 400 may include comparing the first information with the second information. In an embodiment, the comparison may be performed by using a first AI/ML model that is trained to employ a natural language processing (NLP) technique to automatically determine a respective term frequency/inverse document frequency (TF/IDF) similarity score for each message included in the first set of textual messages with respect to each message included in the second set of textual messages. In this aspect, the TF/IDF similarity score refers to a statistical measure that evaluates how relevant a particular word is to a particular document from within a set of documents, or by comparison with another document, by multiplying a first metric that corresponds to how many times the particular word appears within the particular document with a second metric that corresponds to an inverse document frequency of the particular word across the set of documents or by comparison with the other document. For example, if a particular message from within the first set of textual messages includes an identification of a particular financial institution as “Bank ABC” and a particular message from the second set of textual messages also includes an identification of “Bank ABC”, then this will increase the TF/IDS similarity score as between this pair of textual messages. Alternatively, in another embodiment, the comparison may be performed by using a deep learning AI/ML model, such as, for example, a Bidirectional Encodings from Representational Transformers (BERT) model or a large language model (LLM), that is trained to use embeddings to generate a similarity score for each message included in the first set of textual messages with respect to each message included in the second set of textual messages. In this aspect, the BERT model may use token embeddings, which maps words and/or parts of words within a string, and positional embeddings, which provide information about the positions of the tokens in sequence with one another. A cosine similarity between the embeddings may be then be calculated in order to obtain a similarity score. As such, the similarity score may vary between −1.0 and 1.0, and a higher similarity score corresponds to a greater degree of similarity between the textual messages being compared with each other.

In an embodiment, the comparison between the first information and the second information may include a determination of a respective difference between the amount of each corresponding wire transfer and the amount of each corresponding receivable. The comparison may also include a determination of the differences between the dates of the wire transfers and the expected payment dates of the receivables.

At step S412, the process 400 may include using a result of the comparison of step S410 to determine a respective probability that each respective wire transfer matches with each respective receivable. In an embodiment, the determination of each respective probability may be determined by using another AI/ML model that is trained by using historical matching data and that uses a matching algorithm that receives several inputs, including transaction amounts, textual descriptions included in the first and second sets of textual messages, and the similarity scores calculated in step S410 to calculate the respective probability. In this aspect, when the number of incoming wire transfers is equal to M and the number of receivables is equal to N, then the number of respective probabilities to be calculated is equal to M×N. Then, at step S414, the process 400 may include using the determined probabilities to generate an assessment of respective matched pairings of wire transfers with receivables. In an embodiment, the generation of the assessment may be performed by using a predetermined threshold value for the corresponding probability that there is a match between a particular wire transfer and a particular receivable. For example, when the threshold value is set as 90%, then whenever a determination is made that a particular wire transfer has at least a 90% probability of a match with a particular receivable, then this is deemed as being a matched pairing; and whenever a determination is made that the probability that a particular wire transfer matches with a particular receivable is less than 90%, then this is deemed as not being a matched pairing.

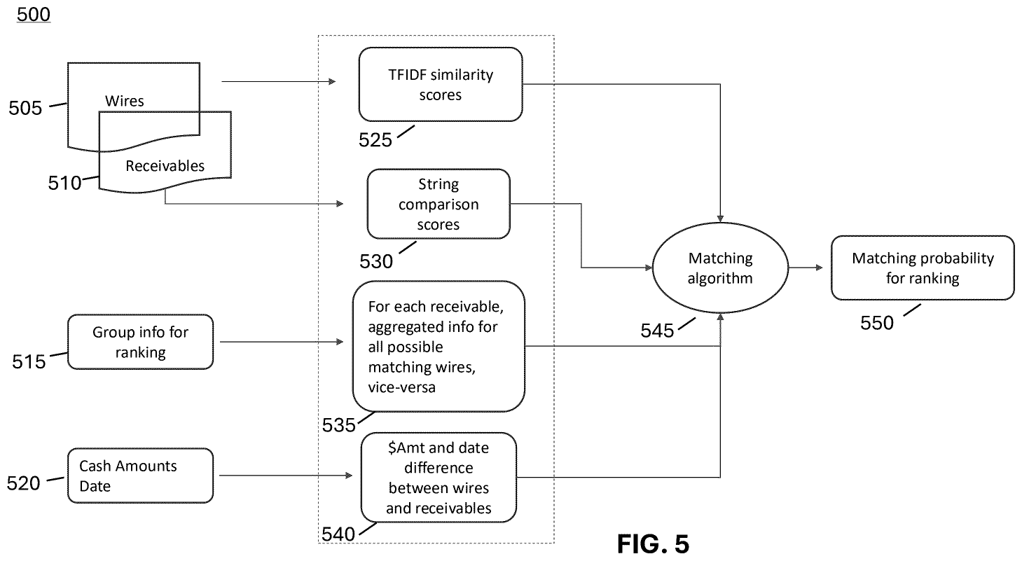

FIG. 5 illustrates a model design 500 that corresponds to a process for using an AI/ML model to perform automated matching of incoming wire transfers with receivables in an accurate and efficient manner, in accordance with an embodiment. As shown in FIG. 5, in an embodiment, similarly as in step S402, textual messages associated with wire transfers 505 may be forwarded to an AI/ML model that, at 525, may determine TF/IDF similarity scores for word tokens and for n-gram tokens and assigns weights to emphasize more relevant textual information and to deemphasize less relevant textual information. As an example, the word token “Bank” may be assigned a relatively low weight, whereas an n-gram token “[Name of bank]” may be assigned a relatively high weight.

Referring again to FIG. 5, in an embodiment, similarly as in step S406, textual messages associated with receivables 510 may be forwarded to the AI/ML model, which, at 530, may determine string comparison scores with respect to the wire transfer textual messages. Further, at 515, group information that is usable for ranking may also be forwarded to the model, which, at 535, may aggregate the information for each receivable with respect to all possible matching wire transfers, and also may aggregate the information for each wire transfer with respect to all possible receivables. In addition, at 520, information that relates to cash amounts and transaction dates may be forwarded to the model, which, at 540, similarly as in step S410, may perform a comparison operation to determine respective differences between wire transfers and receivables.

Referring again to FIG. 5, in an embodiment, at 545, a matching algorithm may receive the TF/IDF similarity scores, the string comparison scores, the aggregated information as between the wire transfers and the receivables, and a result of the comparison operation to determine the differences between the wire transfers and the receivables, and then use all of this information as inputs. Then, at 550, similarly as in step S412, the matching algorithm may output a result that indicates matching probabilities as between the wire transfers and the receivables, and, similarly as in step S414, may provide a ranking that indicates an order that corresponds to the respective probabilities that particular wire transfers match with particular receivables.

In an embodiment, there are several types of matched pairings. In a first type of matched pairing, there is a one-to-one match between a single wire transfer and a single receivable, such that the single wire transfer does not match with any other receivable, and the single receivable does not match with any other wire transfer. In a second type of matched pairing, there is a many-to-one match between at least two wire transfers and exactly one receivable. In a third type of matched pairing, there is a one-to-many match between exactly one wire transfer and at least two receivables. In fourth type of matched pairing, there is a many-to-many match between at least two wire transfers and at least two receivables. In the fourth type of matched pairing, there is at least one wire transfer that matches with at least two different receivables, and there is at least one receivable that matches with at least two different wire transfers.

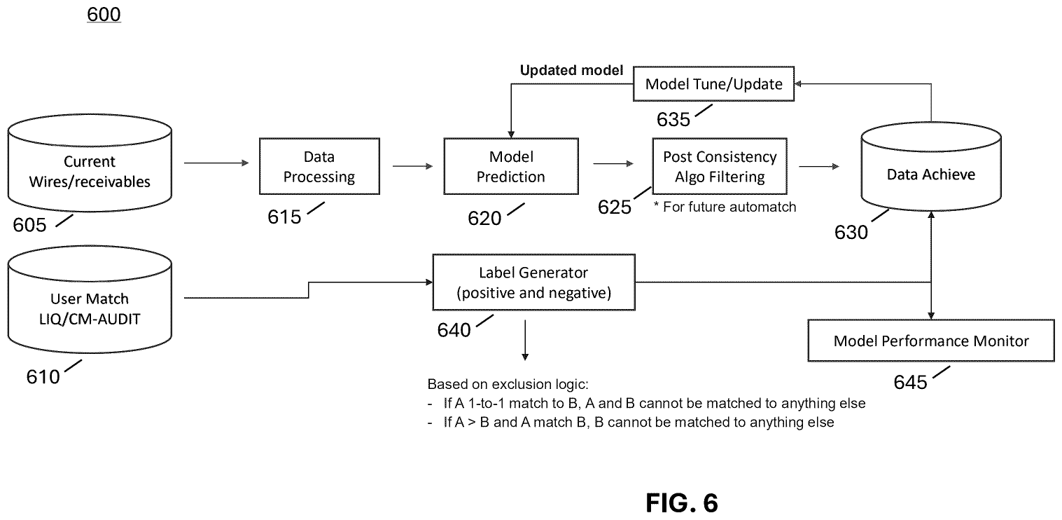

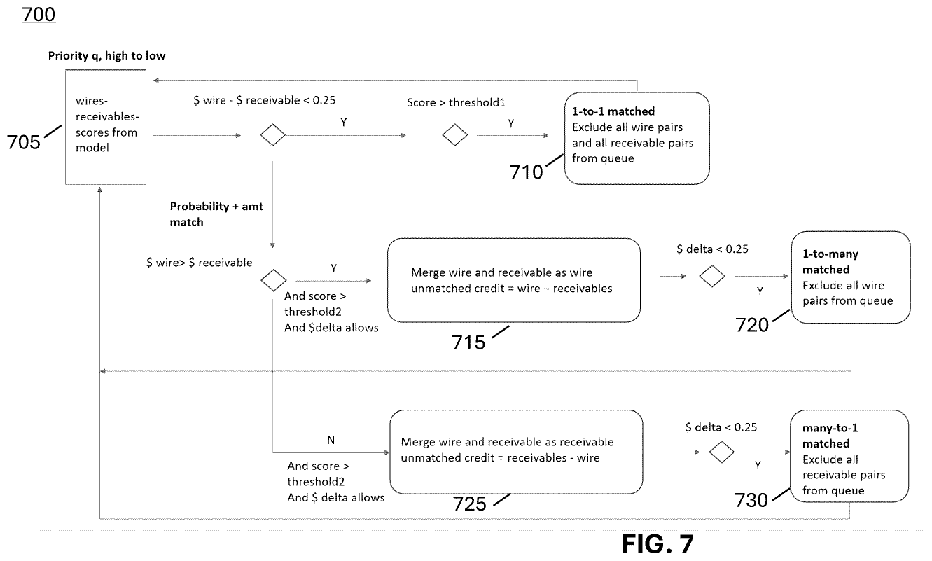

FIG. 6 illustrates a data flow 600 that corresponds to a process for using an AI/ML model to perform automated matching of incoming wire transfers with receivables in an accurate and efficient manner, in accordance with an embodiment. As shown in FIG. 6, similarly as in steps S402 and S406, a current set of wire transfers and a current set of receivables are provided at 605 as inputs to a processor for data processing at 615. As discussed above, similarly as in steps S404 and S408, the data processing may include extracting information from each wire transfer and extracting information from each receivable. Then, at 620, similarly as in steps S410, S412, and S414, the extracted information is submitted to an AI/ML model, which compares the information in order to make predictions regarding which wire transfers have the highest probabilities of matching with which receivables. These predictions are then provided at 625 to a post consistency algorithm filtering process, an example of which is illustrated in FIG. 7 and further discussed below. A result of the post consistency algorithm filtering process is then fed to a data achieve database 630, which then feeds the information back into the AI/ML model at 635 so that the model is kept fully updated and tuned for subsequent operations. In an embodiment, the updating and tuning of the model may be supervised or unsupervised. In addition, the data flow 600 also includes information that is obtained from a user match database at 610 and fed into a label generator module 640 that is configured to perform an exclusion logic test to make sure that there are no matched pairings of wire transfers with receivables that are contradictory/impossible based on the corresponding amounts. A result of the exclusion logic test is then fed to a model performance monitor 645 and also to the data achieve database 630.

FIG. 7 illustrates a logic consistency check 700 that corresponds to a process for using an AI/ML model to perform automated one-to-many matching of incoming wire transfers with receivables in an accurate and efficient manner, in accordance with an embodiment. As illustrated in FIG. 7, the logic consistency check 700 begins with the scores provided at 705 as outputs from the AI/ML model. In a first path, when the amount of a particular wire transfer is very close to the amount of a particular receivable, e.g.,, within less than $0.25, and the score that the model has determined with respect to the probability that there is a match between the particular wire transfer and the particular receivable is greater than a predetermined threshold value, then at 710, a determination is made that this is one-to-one matched pairing, and all other wire transfers and all other receivables are excluded from a queue that corresponds to this particular matched pairing.

Referring again to FIG. 7, in a second path, when the amount of a particular wire transfer is greater than the amount of a particular receivable but the score provided by the model indicates that there is a strong probability (e.g., greater than a predetermined threshold value) of a match, then at 715, they form a matched pairing and the unmatched portion of the amount of the particular wire transfer is calculated as an unmatched credit that is then usable for forming subsequent matched pairings between that same particular wire transfer and other receivables. Then, when the particular wire transfer has been matched with sufficient receivables to account for the full amount of the particular wire transfer, at 720 a one-to-many match is determined, and all other wire transfers are excluded from this queue.

Referring again to FIG. 7, in a third path, when the amount of a particular wire transfer is less than the amount of a particular receivable but the score provided by the model indicates that there is a strong probability (e.g., greater than a predetermined threshold value) of a match, then at 725, they form a matched pairing and the unmatched portion of the amount of the particular receivable is calculated as an unmatched credit that is then usable for forming subsequent matched pairings between that same particular receivable and other wire transfers. Then, when the particular receivable has been matched with sufficient wire transfers to account for the full amount of the particular receivable, at 730 a many-to-one match is determined, and all other receivables are excluded from this queue.

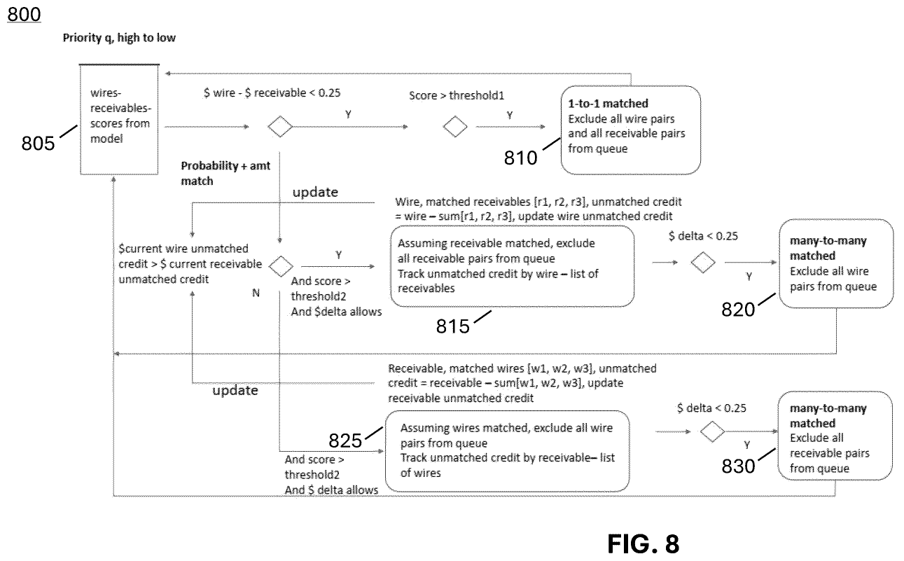

FIG. 8 illustrates a logic consistency check 800 that corresponds to a process for using an AI/ML model to perform automated many-to-many matching of incoming wire transfers with receivables in an accurate and efficient manner, in accordance with an embodiment. As illustrated in FIG. 8, the logic consistency check 800 begins with the scores provided at 805 as outputs from the AI/ML model. In a first path, when the amount of a particular wire transfer is very close to the amount of a particular receivable, e.g., within less than $0.25, and the score that the model has determined with respect to the probability that there is a match between the particular wire transfer and the particular receivable is greater than a predetermined threshold value, then a determination is made at 810 that this is one-to-one matched pairing, and all other wire transfers and all other receivables are excluded from a queue that corresponds to this particular matched pairing.

Referring again to FIG. 8, in a second path, when the amount of a particular wire transfer is greater than the amount of a particular receivable but the score provided by the model indicates that there is a strong probability (e.g., greater than a predetermined threshold value) of a match, then at 815, they form a matched pairing and the unmatched portion of the amount of the particular wire transfer is calculated as an unmatched credit that is then is tracked as being usable for forming subsequent matched pairings between that same particular wire transfer and other receivables. Then, when the particular wire transfer has been matched with sufficient receivables to account for the full amount of the particular wire transfer, at 820 a many-to-many match is determined, and all other wire transfers are excluded from this queue.

Referring again to FIG. 8, in a third path, when the amount of a particular wire transfer is less than the amount of a particular receivable but the score provided by the model indicates that there is a strong probability (e.g., greater than a predetermined threshold value) of a match, then at 825, they form a matched pairing and the unmatched portion of the amount of the particular receivable is calculated as an unmatched credit that is then tracked as being usable for forming subsequent matched pairings between that same particular receivable and other wire transfers. Then, when the particular receivable has been matched with sufficient wire transfers to account for the full amount of the particular receivable, at 830 a many-to-many match is determined, and all other receivables are excluded from this queue.

In some embodiments as disclosed above in FIGS. 1-8, technical improvements effected by the instant disclosure may include a platform for implementing an automated transaction reconciliation module configured for enablement of using an AI/ML model to perform automated matching of incoming wire transfers with receivables in an accurate and efficient manner, but the disclosure is not limited thereto.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium may be a random access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, may be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, may be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method for performing automated matching of incoming wire transfers with receivables, the method being implemented by at least one processor, the method comprising:
receiving a first plurality of textual messages that are associated with a corresponding plurality of wire transfers;
analyzing each message included in the first plurality of textual messages to determine, for each message, respective first information that includes an amount of a corresponding wire transfer, a date, a name of a payor, and a name of an intended recipient;
retrieving, from a memory, a second plurality of textual messages that are associated with a corresponding plurality of receivables;
analyzing each message included in the second plurality of textual messages to determine, for each message, respective second information that includes an amount of a corresponding receivable, an expected payment date, a name of an intended payor, and a name of a payee;
comparing the first information with the second information;
determining, based on a result of the comparing, a respective probability that each particular one of the plurality of wire transfers matches with each particular one of the plurality of receivables; and
generating, based on a result of the determining, an assessment of respective matched pairings of wire transfers included in the plurality of wire transfers with receivables included in the plurality of receivables,
wherein the comparing comprises using a first artificial intelligence/machine learning (AI/ML) model that is trained to employ a natural language processing (NLP) technique to automatically determine a respective term frequency/inverse document frequency (TF/IDF) similarity score for each message included in the first plurality of textual messages with respect to each message included in the second plurality of textual messages.

2. The method of claim 1, wherein the method further comprises inputting a result of the generating of the assessment of the respective matched pairings to a post consistency filtering process by which information that relates to the respective matched pairings is continually fed back to the first AI/ML model for updating and tuning a training of the first AI/ML model for subsequent operations.

3. The method of claim 2, wherein the comparing further comprises using the first AI/ML model to determine, for each message included in the first plurality of textual messages with respect to each message included in the second plurality of textual messages, a respective difference between the amount of the corresponding wire transfer and the amount of the corresponding receivable.

4. The method of claim 3, wherein the comparing further comprises using the first AI/ML model to determine, for each message included in the first plurality of textual messages with respect to each message included in the second plurality of textual messages, a respective difference between the date of the corresponding wire transfer and the expected payment date of the corresponding receivable.

5. The method of claim 1, wherein the generating of the assessment comprises determining that there is a match between a first one of the plurality of wire transfers and a first one of the plurality of receivables when a corresponding probability that the first one of the plurality of wire transfers matches with the first one of the plurality of receivables exceeds a first predetermined threshold value.

6. The method of claim 1, wherein the assessment includes at least one matched pairing of a single wire transfer from among the plurality of wire transfers with a single receivable from among the plurality of receivables, wherein the single wire transfer does not match with any other receivable from among the plurality of receivables, and the single receivable does not match with any other wire transfer from among the plurality of wire transfers.

7. The method of claim 1, wherein the assessment includes a first matched pairing of a first wire transfer from among the plurality of wire transfers with a first receivable from among the plurality of receivables and at least a second matched pairing of a second wire transfer from among the plurality of wire transfers with the first receivable.

8. The method of claim 1, wherein the assessment includes a first matched pairing of a first wire transfer from among the plurality of wire transfers with a first receivable from among the plurality of receivables and at least a second matched pairing of the first wire transfer with a second receivable from among the plurality of receivables.

9. The method of claim 1, wherein the assessment includes a first matched pairing of a first wire transfer from among the plurality of wire transfers with a first receivable from among the plurality of receivables, at least a second matched pairing of a second wire transfer from among the plurality of wire transfers with the first receivable, and at least a third matched pairing of the first wire transfer with a second receivable from among the plurality of receivables.

10. A computing apparatus for performing automated matching of incoming wire transfers with receivables, the computing apparatus comprising:
a processor;
a memory; and
a communication interface coupled to each of the processor and the memory,
wherein the processor is configured to:
receive, via the communication interface, a first plurality of textual messages that are associated with a corresponding plurality of wire transfers;
analyze each message included in the first plurality of textual messages to determine, for each message, respective first information that includes an amount of a corresponding wire transfer, a date, a name of a payor, and a name of an intended recipient;
retrieve, from the memory, a second plurality of textual messages that are associated with a corresponding plurality of receivables;
analyze each message included in the second plurality of textual messages to determine, for each message, respective second information that includes an amount of a corresponding receivable, an expected payment date, a name of an intended payor, and a name of a payee;
compare the first information with the second information;
determine, based on a result of the comparison, a respective probability that each particular one of the plurality of wire transfers matches with each particular one of the plurality of receivables; and
generate, based on a result of the determination, an assessment of respective matched pairings of wire transfers included in the plurality of wire transfers with receivables included in the plurality of receivables,
wherein the processor is further configured to compare the first information with the second information by using a first artificial intelligence/machine learning (AI/ML) model that is trained to employ a natural language processing (NLP) technique to automatically determine a respective term frequency/inverse document frequency (TF/IDF) similarity score for each message included in the first plurality of textual messages with respect to each message included in the second plurality of textual messages.

11. The computing apparatus of claim 10, wherein the processor is further configured to input a result of the generation of the assessment of the respective matched pairings to a post consistency filtering process by which information that relates to the respective matched pairings is continually fed back to the first AI/ML model for updating and tuning a training of the first AI/ML model for subsequent operations.

12. The computing apparatus of claim 11, wherein the processor is further configured to use the first AI/ML model to determine, for each message included in the first plurality of textual messages with respect to each message included in the second plurality of textual messages, a respective difference between the amount of the corresponding wire transfer and the amount of the corresponding receivable.

13. The computing apparatus of claim 12, wherein the processor is further configured to use the first AI/ML model to determine, for each message included in the first plurality of textual messages with respect to each message included in the second plurality of textual messages, a respective difference between the date of the corresponding wire transfer and the expected payment date of the corresponding receivable.

14. The computing apparatus of claim 10, wherein the processor is further configured to determine that there is a match between a first one of the plurality of wire transfers and a first one of the plurality of receivables when a corresponding probability that the first one of the plurality of wire transfers matches with the first one of the plurality of receivables exceeds a first predetermined threshold value.

15. The computing apparatus of claim 10, wherein the assessment includes at least one matched pairing of a single wire transfer from among the plurality of wire transfers with a single receivable from among the plurality of receivables, wherein the single wire transfer does not match with any other receivable from among the plurality of receivables, and the single receivable does not match with any other wire transfer from among the plurality of wire transfers.

16. The computing apparatus of claim 10, wherein the assessment includes a first matched pairing of a first wire transfer from among the plurality of wire transfers with a first receivable from among the plurality of receivables and at least a second matched pairing of a second wire transfer from among the plurality of wire transfers with the first receivable.

17. The computing apparatus of claim 10, wherein the assessment includes a first matched pairing of a first wire transfer from among the plurality of wire transfers with a first receivable from among the plurality of receivables and at least a second matched pairing of the first wire transfer with a second receivable from among the plurality of receivables.

18. The computing apparatus of claim 10, wherein the assessment includes a first matched pairing of a first wire transfer from among the plurality of wire transfers with a first receivable from among the plurality of receivables, at least a second matched pairing of a second wire transfer from among the plurality of wire transfers with the first receivable, and at least a third matched pairing of the first wire transfer with a second receivable from among the plurality of receivables.

19. A non-transitory computer readable storage medium storing instructions for performing automated matching of incoming wire transfers with receivables, the storage medium comprising executable code which, when executed by a processor, causes the processor to:
receive a first plurality of textual messages that are associated with a corresponding plurality of wire transfers;
analyze each message included in the first plurality of textual messages to determine, for each message, respective first information that includes an amount of a corresponding wire transfer, a date, a name of a payor, and a name of an intended recipient;
retrieve, from a memory, a second plurality of textual messages that are associated with a corresponding plurality of receivables;
analyze each message included in the second plurality of textual messages to determine, for each message, respective second information that includes an amount of a corresponding receivable, an expected payment date, a name of an intended payor, and a name of a payee;
compare the first information with the second information;
determine, based on a result of the comparison, a respective probability that each particular one of the plurality of wire transfers matches with each particular one of the plurality of receivables; and
generate, based on a result of the determination, an assessment of respective matched pairings of wire transfers included in the plurality of wire transfers with receivables included in the plurality of receivables,
wherein when executed by the processor, the executable code further causes the processor to compare the first information with the second information by using a first artificial intelligence/machine learning (AI/ML) model that is trained to employ a natural language processing (NLP) technique to automatically determine a respective term frequency/inverse document frequency (TF/IDF) similarity score for each message included in the first plurality of textual messages with respect to each message included in the second plurality of textual messages.

20. The storage medium of claim 19, wherein when executed by the processor, the executable code further causes the processor to input a result of the generation of the assessment of the respective matched pairings to a post consistency filtering process by which information that relates to the respective matched pairings is continually fed back to the first AI/ML model for updating and tuning a training of the first AI/ML model for subsequent operations.
